(19) United States
(12) Patent Application Publication
(10) Pub. No.: US 2002/0048252 A1
(43) Pub. Date: Apr. 25, 2002

(54) Magnetic device

(76) Inventor: Chii-How Chang, Taoyuan Shien (TW)

Correspondence Address: TROJAN LAW OFFICES, 9250 WILSHIRE BLVD, SUITE 325, BEVERLY HILLS, CA, 90212

(21) Appl. No.: 09/860,695

(22) Filed: May 16, 2001

(30) Foreign Application Priority Data
Oct. 25, 2000 (TW) 089218573

(51) Int. Cl. G11B 21/16; G11B 7/00; H02K 41/00; G11B 17/00

(52) U.S. Cl. 369/244; 310/12; 369/44.14

(57) ABSTRACT

A magnetic device for being used in a driver is provided. The magnetic device includes a permanent magnet unit, a first yoke unit positioned corresponding to the permanent magnet unit, a second yoke unit having one end connected with the first yoke unit, and a coil complex having a double-cross type for generating magnetic force, wherein the permanent magnet unit, the first yoke unit and the second yoke unit are used for generating a magnetic circuit, and the magnetic force generated from the coil complex interacts with the magnetic circuit.

### FIELD OF THE INVENTION

The present invention relates to a magnetic device, and more particularly to a magnetic device for being used in a read/write head.

### BACKGROUND OF THE INVENTION

Generally, data-recording media for accessing and recording the data are supported by drivers. The magnetic recording devices, for example, soft discs or hard discs, have drivers for magnetic read/write heads. The optical recording devices, for example, CD, VCD or DVD, have corresponding drivers for optical read/write heads. In addition, MO or MD has corresponding drivers for read/write heads. The drivers are used for precisely directing the read/write heads to the working positions.

FIGS. 1 to 4 are schematic views showing the conventional objective lens drivers. According to the movable member V of the conventional objective lens drivers, the drivers are divided into two types as follows.

a) moving coils: the movable member V has a focusing coil F1 and perpendicular tracking coils T1, T2 and T3 thereon as shown in FIGS. 1 to 3.

b) moving magnets: the movable member V has permanent magnets M1 and M2 thereon as shown in FIG. 4.

However, the theories applied in the drivers are similar. The magnetic field generated by the permanent magnets M1 and M2 and the yokes Y1, Y2 and Y3. When electric current passes through the focusing coils F1 and F2 or the tracking coils T1, T2 and T3, another variable magnetic field is generated owing to electromagnetic induction, and then the relative displacement between the coils and the magnets are generated. The variable relative displacement is regulated by the electric current.

The conventional drivers have several drawbacks. The magnetic force lacks the linear characteristic, so that it is difficult for the drivers to precisely direct the read/write heads to the working positions.

For example, the movable member V shown in FIG. 3 for carrying the objective lens and the coils wound thereon should be produced in advance in the fabricating process. The fabricating process is complicated, and the coils are wounded on the movable member with difficulty. It is more complicated that the coils are wound in advance, and then fixed to the movable member.

For the moving magnets type drivers, the permanent magnets M1 and M2 are connected with the movable member V shown in FIG. 4. However, the magnets are much heavier than the coils, so that the sensitivity and the precision of the driver are reduced due to the heavy weight.

In order to overcome the foresaid drawbacks, the present invention provides a magnetic device for being used in a driver.

### SUMMARY OF THE INVENTION

It is therefore an object of the present invention to provide a magnetic device for being used in a driver.

In accordance with the present invention, the magnetic device includes a permanent magnet unit, a first yoke unit positioned corresponding to the permanent magnet unit, a second yoke unit having one end connected with the first yoke unit, and a coil complex having a double-cross type for generating magnetic force.

The permanent magnet unit, the first yoke unit and the second yoke unit are used for generating a magnetic circuit, and the magnetic force generated from the coil complex interacts with the magnetic circuit.

Preferably, the permanent magnet unit has a plurality of permanent magnets.

In accordance with the present invention, the coil complex includes a first coil unit wound around the second yoke unit, and a second coil unit perpendicularly wound around the first coil unit.

The magnetic force generated by the first coil unit interacts with the magnetic circuit to generate a first force for movement in a first direction.

The magnetic force generated by the second coil unit interacts with the magnetic circuit to generate a second force for movement in a second direction.

The first direction is perpendicular to the second direction.

Preferably, the first coil unit has a plurality of focusing coils, and the second coil unit has a plurality of tracking coils.

Preferably, the first coil unit is a focusing coil, and the second coil unit has two tracking coils. The two tracking coils are wounded around two ends of the focusing coil to form the double-cross type.

Preferably, the driver is an optical read/write head having a movable member. The coil complex is connected with the movable member. The movable member has an objective lens thereon.

The present invention may best be understood through the following descriptions with reference to the accompanying drawings, in which:

### BRIEF DESCRIPTION OF THE DRAWINGS

FIGS. 1 to 4 are schematic views showing the conventional objective lens drivers;

FIG. 5 is the schematic view showing the magnetic device according to the first preferred embodiment of the present invention;

FIG. 6 is the schematic view showing the magnetic device according to the second preferred embodiment of the present invention;

FIG. 7 is the schematic view showing the magnetic device in FIG. 6 applied in an objective lens driver according to the present invention;

FIG. 8 is the schematic view showing the magnetic device according to the third preferred embodiment of the present invention; and

FIG. 9 is the schematic view showing the magnetic device in FIG. 8 applied in an objective lens driver according to the present invention.

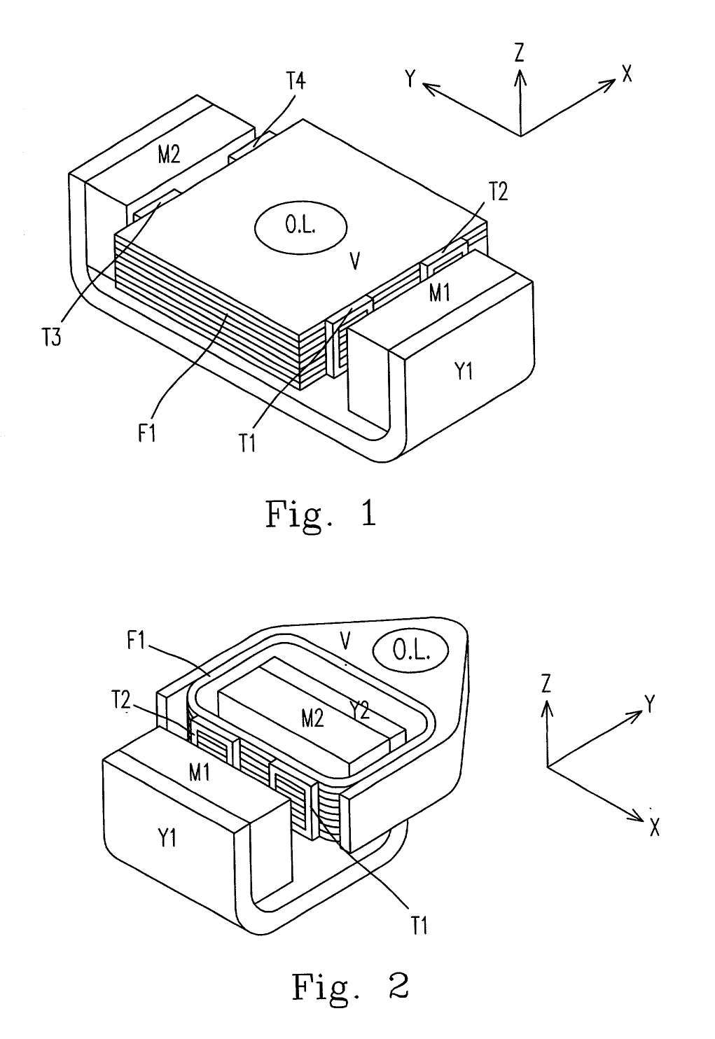

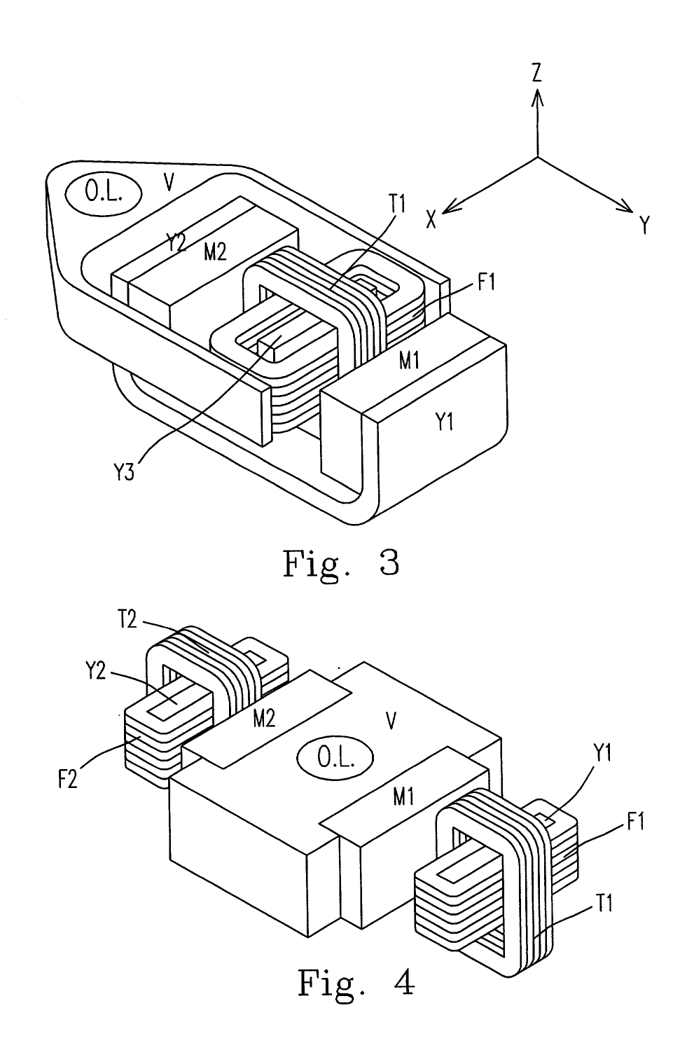

### DETAILED DESCRIPTION OF THE PREFERRED EMBODIMENTS

The present invention provides a magnetic device for being used in a driver. A specific combination of a coil complex having a double-cross type and yokes having a specific appearance are used for generating the magnetic force having a better linear characteristic to improve the sensitivity of the driver and simplify the fabricating process of the driver.

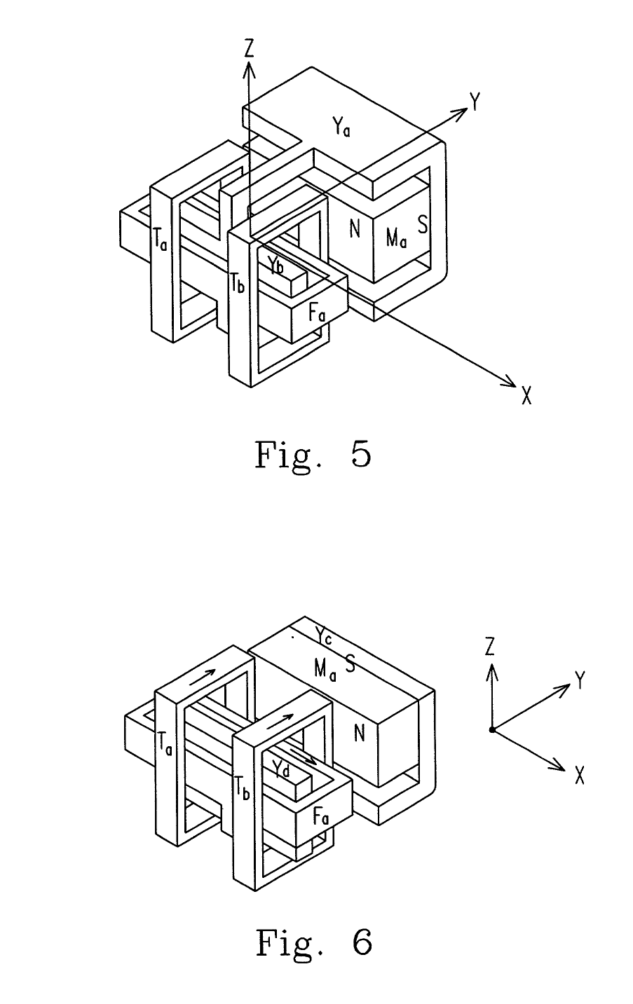

Please refer to FIG. 5. Mₐ is a permanent magnet. The tracking coils Tₐ and T_{b} are wound around the focusing coil Fₐ to form a double-cross coil complex. A fixed yoke Y_{b} is further contained in the coil complex, and the fixed yoke Y_{b} is connected with a fixed yoke Yₐ outside the coil complex. The magnetic lines of force are distributed in the yokes Yₐ and Y_{b}. The magnetic force generated by the tracking coils Tₐ and T_{b} interacts with the magnetic circuit generated by the permanent magnets and the yokes to generate a magnetic force along the X axis. The magnetic force generated by the focusing coils Fₐ interacts with the magnetic circuit to generated a magnetic force along the Z axis.

The present invention provides a magnetic device having a simpler structure than the conventional device. The coil is wound individually, and the wound coils are combined with the yokes. The fabricating process of the device is simplified. Furthermore, the movable member is lighter than the conventional device, so that the sensitivity is better than the conventional device.

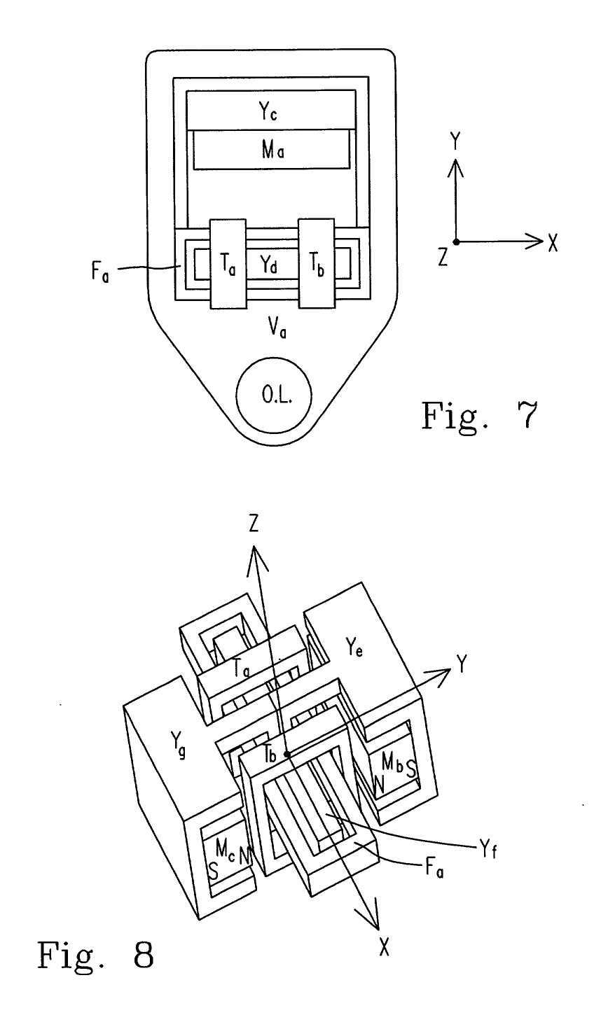

FIG. 6 is a schematic view showing the magnetic device according to the second preferred embodiment of the present invention. The yokes Y_{c} and Y_{d} respectively have a half volume of the yokes Yₐ and Y_{b} shown in FIG. 5, and the Hence, the effect of the device is not reduced. Hence, the magnetic device further provides an advantage that the material of the device is reduced. FIG. 7 is a schematic view showing the magnetic device further including the movable member Vₐ and the objective lens O.L.

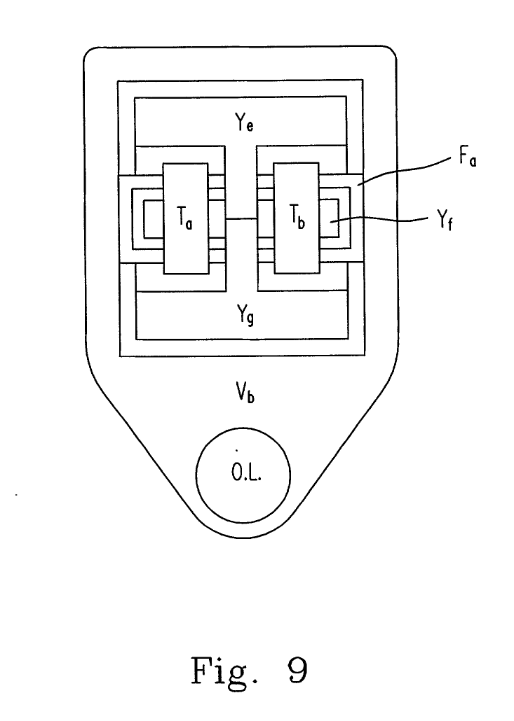

FIG. 8 is a schematic view showing the magnetic device according to the third preferred embodiment of the present invention. The permanent magnets M_{c} and M_{d} and the yokes Yₑ, Y_{f} and Y_{g} are used in the magnetic device. FIG. 9 is a schematic view showing the magnetic device further including the movable member Vₐ and the objective lens O.L.

The present invention has the advantage as follows.

1.) The present invention is used for generating the magnetic force having a better linear characteristic to improve the sensitivity of the driver.

2.) The present invention provides a simpler fabricating process of the driver than the conventional driver.

3.) The present invention is used for reducing the material cost.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A magnetic device for being used in a driver, comprising:
a permanent magnet unit;
a first yoke unit positioned corresponding to said permanent magnet unit;
a second yoke unit having one end connected with said first yoke unit; and
a coil complex having a double-cross type for generating magnetic force,
wherein said permanent magnet unit, said first yoke unit and said second yoke unit are used for generating a magnetic circuit, and said magnetic force generated from said coil complex interacts with said magnetic circuit.

2. The magnetic device according to claim 1, wherein said permanent magnet unit has a plurality of permanent magnets.

3. The magnetic device according to claim 1, wherein said coil complex comprises:
a first coil unit wound around said second yoke unit; and
a second coil unit perpendicularly wound around said first coil unit.

4. The magnetic device according to claim 3, wherein said magnetic force generated by said first coil unit interacts with said magnetic circuit to generate a first force for movement in a first direction.

5. The magnetic device according to claim 4, wherein said magnetic force generated by said second coil unit interacts with said magnetic circuit to generate a second force for movement in a second direction.

6. The magnetic device according to claim 5, wherein said first direction is perpendicular to said second direction.

7. The magnetic device according to claim 3, wherein said first coil unit has a plurality of focusing coils.

8. The magnetic device according to claim 3, wherein said second coil unit has a plurality of tracking coils.

9. The magnetic device according to claim 3, wherein said first coil unit is a focusing coil.

10. The magnetic device according to claim 9, wherein said second coil unit has two tracking coils.

11. The magnetic device according to claim 10, wherein said two tracking coils are wounded around two ends of said focusing coil to form said double-cross type.

12. The magnetic device according to claim 1, wherein said driver is used in an optical read/write head having a movable member.

13. The magnetic device according to claim 12, wherein said coil complex is connected with said movable member.

14. The magnetic device according to claim 13, wherein said movable member has an objective lens thereon.
